(19) United States
(12) Patent Application Publication
(10) Pub. No.: US 2022/0345378 A1
(43) Pub. Date: Oct. 27, 2022

(54) ELECTRONIC PAPER-BASED DISPLAY DEVICE NODE FAULT VISUALIZATION

(71) Applicant: HEWLETT PACKARD ENTERPRISE DEVELOPMENT LP, Houston, TX (US)

(72) Inventors: Peter Guyan, Bracknell (GB); Lee M. Morecroft, Bracknell (GB); Andy Warner, Bloomington, MN (US)

(21) Appl. No.: 17/239,815

(22) Filed: Apr. 26, 2021

(51) Int. Cl. H04L 12/24; G06F 3/14; G06F 3/0483; G09G 3/34

(52) U.S. Cl. CPC H04L 41/22; G06F 3/14; G06F 3/0483; G09G 3/3453; H04L 41/0677; G09G 2354/00; G09G 2330/02

(57) ABSTRACT

An apparatus includes a chassis; a plurality of nodes that are mounted to the chassis; an electronic paper-based display device that is mounted to the chassis; and a management controller that is mounted to the chassis. Each node is associated with a different operating system instance of a plurality of operating system instances. The management controller, in response to a fault associated with a given node, provides data to cause the electronic paper-based display device to visually display an identity of the given node and information about the fault.

### BACKGROUND

A cluster is a group of interconnected computers, or nodes, which combine their individual processing powers to function as a single, high performance machine. A cluster may be used for a number of different purposes, such as load balancing, high availability (HA) server applications and parallel processing.

### BRIEF DESCRIPTION OF THE DRAWINGS

FIG. 1 is a perspective view of a server blade having an associated electronic paper-based display device, which is controlled by a baseboard management controller of the server blade to display node fault information according to an example implementation.

FIG. 2 is an illustration of visual content that is displayed on the electronic paper-based display device of FIG. 1 according to an example implementation.

FIG. 3 is a schematic diagram of a motherboard of the server blade of FIG. 1 according to an example implementation.

FIGS. 4 and 5 are flow diagrams depicting processes performed by the baseboard management controller according to example implementations.

FIG. 6 is a schematic diagram of an apparatus that includes an electronic paper-based display device and a management controller to cause the electronic paper-based display device to visually display an identity of a given node and information about a fault that is associated with the given node according to an example implementation.

FIG. 7 is a flow diagram depicting a process that is performed by a management controller to display fault information on an electronic paper-based display device according to an example implementation.

FIG. 8 is an illustration of machine-executable instructions stored on a non-transitory machine-readable storage medium to cause a machine to provide data to cause an electronic paper-based display device to display fault information for a server and an identification of the server according to an example implementation.

### DETAILED DESCRIPTION

When a node of a cluster experiences a problem, or incurs a “fault,” it may be of importance for a field service technician to quickly and accurately identify the physical location of the node so that the appropriate remedial action may be initiated to bring the node back online. Correctly identifying the location of the specific node also reduces the risk of removing or servicing an incorrect component of the cluster (e.g., removing a server blade other than the blade containing the affected node).

The node may be part of a field replaceable unit (FRU) of the cluster, such as a rack-based server tray (herein called a “server blade”), and the location of the node may involve identifying a specific server blade and identifying a particular central processing unit (CPU) package (or “chip”) on the server blade. The field service technician may perform any of a number of on-site actions, as appropriate, such as replacing the server blade, or addressing or further investigating a problem that is associated with the server blade, such as addressing a network cabling issue, evaluating a network switch, and so forth.

Identifying the on-site physical location of a node may be a daunting task, especially if the node is part of a large scale cluster (e.g., an exascale high performance computing (HPC) cluster) that has a relatively large number of nodes, such as hundreds, if not thousands or tens of thousands of nodes. The nodes of such a cluster may be located in a number of rack-based computer systems, or “racks;” and the racks may be distributed over one or multiple data centers. Moreover, not all of the nodes in a given data center may be organized in adjacent racks and rows of the data center due to the nature in which rack space is purchased.

A server blade may have a paper label for purposes of writing content to identify information about the server blade, such as information that provides an identification (ID) of the server blade, IDs of nodes on the server blade, and so forth. However, the paper label may be missing, damaged, accidently removed; or the paper label's content may not be updated to reflect changes (e.g., the content on the paper label may not be updated when a node is moved to another server blade). Moreover, because a server blade may contain multiple nodes, the location of the node within the server blade may not be documented via the paper label.

Although a paper label on a server blade may allow a service technician to document notes about the nodes of the server blade (e.g., document diagnoses of problems with node(s), dates of the diagnoses, service actions taken, and so forth), this information may be obfuscated if the paper label is missing or damaged. Moreover, the notes of one field service technician from a previous service call may be illegible to the field service technician performing the current service call. Although a field service technician could conceivably take notes about nodes or server blades using a portable electronic device (e.g., a tablet, a laptop computer, a notebook computer, and so forth), the data center may be a secure environment governed by a security policy that prohibits the use of such on-site portable electronic devices.

In accordance with example implementations that are described herein, an FRU of a computer system, such as a server blade, has an attached persistent, electronic label that provides visual information that may serve any of a number of purposes, such as identifying the physical location of the FRU (e.g., a rack location, a chassis unit location or “u-position” location within the rack, a data center row location, a data center identifier, and so forth) and identifying the locations of nodes within the server blade (e.g., identifying CPU socket identifiers). Therefore, the persistent electronic label may allow the location of a particular node to be readily identified by a field service technician and allow the specific location of a removed server blade to be tracked for purposes of analysis and/or future replacement. The persistent, electronic label may also be used to visually display fault information (e.g., fault code(s)) for the nodes of the server blade, service history(ies), of the server blade and/or its nodes, and so forth.

More specifically, in accordance with example implementations, the persistent, electronic label may be provided by an electronic paper-based display device (e.g., a display device employing electronic ink technology), which has a flexible display substrate that provides a visual content (e.g., text and/or image(s)) that is static, i.e., the visual content of the display survives a power loss so that the visual content remains (e.g., remains indefinitely) without any electricity being received by the display device. As described herein, in accordance with example implementations, the FRU may include a management controller (e.g., a baseboard management controller of the server blade or a chassis management controller of the chassis unit containing the server blade) that manages the visual content of the electronic paper-based display device.

In accordance with example implementations, the management controller's management of the visual content of the electronic paper-based display device may include the management controller autonomously detecting a fault with the node; categorizing or classifying the fault; and providing data to display visual content about the node or its fault on the electronic paper-based display device, such as an identifier for the node, a fault code, a time associated with the fault, and so forth. Moreover, in accordance with example implementations, the management controller's management of the visual content of the electronic paper-based display device may include the management controller receiving data from another entity (e.g., a remote management server, a portable electronic device of a field service technician, and so forth) and displaying visual content on the display device based on the received data. More specifically, the received data may represent visual content (e.g., fault code, a proposed remedy to resolve the fault, technician notes about a node fault, and so forth) for the management controller to display on the electronic paper-based display device.

The persistence of the display device's visual content ensures that an FRU, such as a server blade, is properly identified by service personnel; an affected node is properly identified by service personnel; fault codes and possibly other information about faults are preserved; and node location information is preserved. In accordance with example implementations, the visual content of the display device remains after the FRU has been powered down and remains after the FRU is removed from the rack.

In accordance with example implementations, the electronic paper-based display device may be configured to receive supplemental power from a supplemental, stored energy source (e.g., a super capacitor or a battery) in the event that the FRU containing the display device experiences a power loss (e.g., a server blade containing a node experiencing a fault is powered down as a mitigation measure). Although unneeded to make the visual content persistent, this supplemental power allows the management controller to update or change the visual content after electricity to the electronic paper-based display device has been removed.

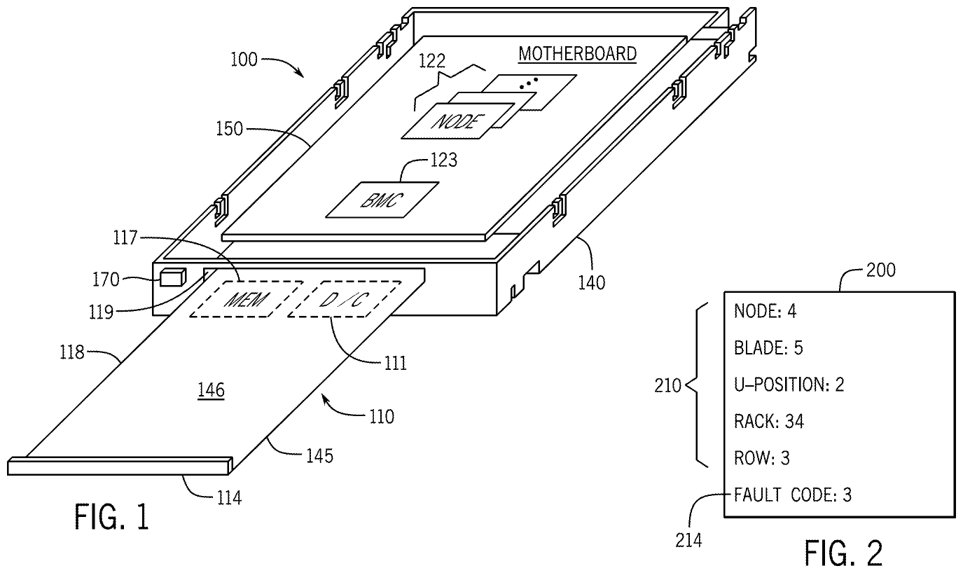

Referring to FIG. 1, as a more specific example, in accordance with some implementations, a cluster may include various nodes 122, such as compute nodes; one or multiple administrative nodes; data transfer nodes; storage nodes; and so forth. In this context, a “node” refers to an entity that includes one or multiple processing cores (e.g., CPU cores, graphics processing unit (GPU) cores, field programable gate arrays (FPGAs), node accelerator cores, and so forth) and corresponds to a single operating system (OS) instance. In accordance with example implementations, a node may be considered a server. A node may be formed from all or part of an actual, physical machine; and the node may include and/or correspond to one or multiple virtual components or virtual environments of a physical machine.

As further described herein, in accordance with example implementations, a node 122 may be formed from one or multiple processing cores of a server tray (called a “server blade 100” herein). In accordance with further implementations, a node 122 may be formed from one or multiple processing cores that are part of a hardware platform other than a server blade, such as a non-rack mounted platform, a rack-mounted server, and so forth. In accordance with example implementations, the server blade 100 may be considered an FRU, i.e., a unit that may be removed and/or replaced by a field service technician. A given node 122 may be part of an FRU (e.g., a chassis module, or unit) other than a server blade, in accordance with further implementations.

In accordance with example implementations, the server blade 100 may have a frame, or chassis 140; one or multiple motherboards 150 may be mounted to the chassis 140; and each motherboard 150 may contain one or multiple multicore CPU semiconductor packages (or “sockets” or “chips”). Depending on the particular implementation, there may be one or multiple CPU semiconductor packages per node, with each node containing multiple processing cores.

In general, the server blade 100 may have a form factor, mechanical latch(es) and corresponding electrical connectors for purposes of allowing the server blade 100 to be installed in and removed from a corresponding server blade opening, or slot, in a rack. As a more specific example, in accordance with some implementations, the server blade 100 may contain two motherboards 150, and each motherboard 150 may contain four nodes 122 that may be formed from groups of processing cores (e.g., CPU processing cores, graphics processing unit (GPU) cores, and so forth).

In accordance with example implementations, the nodes 122 may be assigned unique identifiers (e.g., each node 122 may be assigned a different numeric or alphanumeric sequence). Moreover, a given node 122 may, in accordance with example implementations, have a specific physical location on a particular server blade 100. For example, a particular server blade 100 may have four CPU semiconductor packages that are mounted in four corresponding CPU sockets (e.g., two sockets per motherboard 150) and having corresponding socket identifications (IDs); and a given node 122 may be associated with one or multiple CPU sockets. As such, in accordance with example implementations, a given node 122 may have the following physical location attributes: a data center ID; a data center row ID; a rack ID; a chassis unit ID (or u-position); a server blade ID; and socket ID(s).

In accordance with example implementations, the server blade 100 may contain a management controller. As depicted in FIG. 1, in accordance with some implementations, one of the motherboards 150 of the server blade 100 may contain the baseboard management controller 123. As described further herein, in accordance with example implementations, the baseboard management controller 123 manages the visual content that appears on an electronic paper-based display device 110 that is mounted to the chassis 140. The visual content, in general, includes information pertaining to any detected faults with the nodes 122 and information about the physical location(s) of the node(s) 122. Because the electronic paper-based display device 110 is mounted to the chassis 140, the display device 110 remains with the server blade 100 (and with the nodes 122), in the event that the server blade 100 is removed from its rack. The visual content of the electronic paper-based display device 110 is persistent, in that the visual content remains (e.g., remains indefinitely), even if all electricity to the display device 110 is removed.

Referring to FIG. 2 in conjunction with FIG. 1, in accordance with some implementations, the baseboard management controller 123 may generate data and communicate this data to the electronic paper-based display device 110 for purposes of causing the display device 110 to display visual content 200 pertaining to any node(s) 122 of the server blade 100, which may have experienced a fault. In this context, a “fault,” refers to a failure of a node 122, such as a failure of hardware and/or software of the node 122. Moreover, a “failure,” or “fault,” of a node 122 refers to the inability of the node 122 to function for a particular purpose, such as the failure to operate as intended without incurring bugs or other failures, operate in a trusted manner, and so forth.

For the example implementation depicted in FIG. 2, the visual content 200 may include node information 210 identifying one or multiple nodes 122 of the server blade 100, which have experienced faults, and as such, may need evaluation and/or servicing by a service field technician. For the specific example of FIG. 2, the node information 210 may identify a particular node (here, “Node 4”) and as such, may identify the location of the affected node on the server blade 100. Moreover, as also depicted in FIG. 2, for this example, the node information 210 contains other location attributes of the affected node 122, such as a server blade identification (here, “Blade 5”); a vertical, or u-position, of the server blade 100 (here, a “u-position 2”); a rack identifier (here, “Rack 34”); and a data center row (here, “Row 3”). It is noted that, in accordance with further implementations, the node information 210 may contain more or less node identifying information. In accordance with further implementations, the node information 210 may identify, for example, a particular data center that is associated with the affected node 122. As another example, in accordance with further implementations, the node information 210 may identify a unique identifier for the node 122 or a pattern (e.g., a Quick Response (QR) code), which a service technician may scan to retrieve information relating to information for the node 122, such as an identification for the node 122, a diagnosis for the node 122, service actions that have been taken for the node 122, and so forth.

As also depicted in FIG. 2, in accordance with some implementations, the visual content 200 that is displayed on the electronic paper-based display device 110 may contain information other than node location information, such as a fault code 214 (here, “Fault Code 34”), which may be an identifier for a specific fault. The fault code may, for example, identify a specific hardware or software fault for the node 122. The visual content 200 may contain other and/or different information other than node location and fault codes (e.g., service history, configuration information, and so forth), in accordance with further implementations.

In accordance with some implementations, the electronic paper-based display device 110 may be fixed in position relative to a frame or chassis of the FRU (e.g., the display device 110 may be surface-mounted to an exterior surface of the FRU). Referring to FIG. 1, in accordance with example implementations, the electronic paper-based display device 110 may be mounted to the server blade 100 in a way that allows the display device 110 to translate (e.g., pivot, rotate, slide and so forth) with respect to the chassis 140. For example, as depicted in FIG. 1, in accordance with some implementations, the electronic paper-based display device 110 may be slidably mounted to the chassis 140. Such translational mounts for the electronic paper-based display device 110 allow the display device 110 to have a compact profile when not being used while still allowing for the display device 110 to be extended to view the device's visual content.

For the specific example of FIG. 1, the electronic paper-based display device 110 may be retracted into and extended out of an elongated slot 119 that is formed in a front wall of the chassis 140. As such, for this example implementation, the electronic paper-based display device 110 may have a retracted position (i.e., a position in which the display device 110 is retracted into the server blade 100) and an extended position (i.e., the position that is depicted in FIG. 1 in which the display device 110 has been extended to allow viewing of the display device's visual content).

As another variation, in accordance with further implementations, an electronic paper-based display device 110 may be translationally mounted to an FRU other than a server blade, such as, for example, a chassis unit. As another variation, an electronic paper-based display device 110 may be mounted to a rack that contains one or multiple FRUs (e.g., one or multiple server blades).

Still referring to FIG. 1, as a more specific example, in accordance with some implementations, the electronic paper-based display device 110 may be part of a pull-out tab assembly 145 that is slidably mounted to a drawer slide mount (not shown). In general, the pull-out tab assembly 145, in accordance with example implementations, includes a handle 114 that is affixed to one end of the display device 110, such that in the display device's retracted position, the handle 114 remains accessible outside of the chassis 140, with the remainder of the assembly 145 being disposed inside the server blade 100. When the electronic paper-based display device 110 is retracted, the display device 110 may be extended by gripping the handle 114 and exerting an outward pulling force to externally extend the tab assembly 145 beyond the longitudinal slot 119. For purposes of restoring the electronic paper-based display device 110 to its retracted position, a pushing force may be exerted on the handle 114.

In accordance with a further example implementation, the server blade 100 may have a spring-loaded drawer slide mount for the tab assembly 145 with a push-to-open latch. In this manner, when the tab assembly 145 is in its retracted position, a pushing force may be exerted on the handle 114 to release the push-to-open latch and release a force that is exerted by the spring-loaded drawer slide mount to extend the tab assembly 145. Conversely, a pushing force on the handle 114 may be used to restore the tab assembly 145 to its retracted position and reenergize the spring-loaded drawer slide mount.

In accordance with example implementations, the electronic paper-based display device 110 may be constructed to display a particular page of potentially multiple pages of visual content (i.e., display one page of multiple stored pages at a time). For example, in accordance with some implementations, the example visual content 200 of FIG. 2 may be a particular page of potentially multiple pages that may be displayed on the electronic paper-based display device 110.

In accordance with some implementations, the electronic paper-based display device 110 may contain a display controller 111; a flexible substrate 118 having an outer surface 146 upon which the visual content appears; and a memory 117 to store data (e.g., data provided by the baseboard management controller 123), which represents one or multiple pages of visual content. In accordance with some implementations, the baseboard management controller 123 may communicate visual content data with the display controller 111 for purposes of storing the data in the memory 117. The display controller 111 may, based on the data stored in the memory 117, generate the appropriate electrical signals to produce the visual content that is displayed on the electronic paper-based display device 110.

For purposes of allowing a human viewer to control which particular page (of potentially multiple pages) that is displayed on the electronic paper-based display device 110, in accordance with some implementations, the server blade 100 may have one or multiple user controls, such as a single toggle-based control button 170 that is mounted to the chassis 140. As depicted in FIG. 1, the control button 170 may be accessible on the outside of the chassis 140 near the elongated slot 119, such that when the electronic paper-based display device 110 is in its extended position (as depicted in FIG. 1), the human viewer may toggle the button 170 (e.g., depress and release the button 170) to sequence through the pages of visual content that are displayed on the display device 110. In accordance with example implementations, the display controller 111 may respond to each toggle of the button 170 to sequence to another set of data in the memory 117 for purposes of controlling the display device 110 to display the corresponding page of visual content. The sequencing via the button 170 may be circular in nature. In accordance with further implementations, the server blade 100 may have multiple user controls, such as, for example, an “up” button and a “down” button to control the sequencing through the pages for display on the electronic paper-based display device 110.

In the context of this application, an “electronic paper-based display device” generally refers to an electronic component that may be controlled (e.g., controlled by providing data representing visual content) to display a static visual content in a display region of the component, and the static visual content remains displayed, when all electricity is removed from the electrical component. In other words, electricity is not needed for purposes of making the displayed visual content static. In accordance with some implementations, the electronic paper-based display device may contain a flexible substrate that contains display elements that may be electrically-controlled to arrange the display elements to provide visual content for the display device, with the arrangement of the display device remaining after electricity is removed from the device.

In accordance with some implementations, the electronic paper-based display device may be a component that mimics the appearance of ink on paper. Similar to the appearance of ink on paper, the visual content (e.g., text and/or images) is formed by light reflecting off a substrate, and the visual content remains when no electricity is present.

In accordance with example implementations, the electronic paper-based display device may be an electrophoretic display component, in which a visual content is formed by controllably applying an electric field to pigmented particles, or display elements. For example, the electrophoretic display component may include spherically-shaped or elliptically-shaped display elements that correspond to individual pixels. More specifically, each display element may have, for example, a spherical substrate, and each hemisphere of the substrate may be pigmented with a different color. For example, one hemisphere may be pigmented with a white color (e.g., a background color), and the other hemisphere may be pigmented with a black color (e.g., a foreground color). The electrophoretic display component receives voltages (e.g., voltages from a display controller, such as display controller 111 of FIG. 1), which produces electric fields to controllably physically orient the display elements to display a particular content. In other words, the electric fields may, for example, cause some of the display elements to be oriented to display corresponding white pixels, with the remaining display elements to be oriented to display black pixels. It is noted that the electrophoretic display component may have more than two colors, in accordance with further implementations. When the electric fields are removed (such as the case, for example, when power is removed from the display device), the individual orientations of the display elements do not change. In other words, although the visual content of the electronic ink-based display device may be changed when power is received by the display device, the visual content at any particular time is persistent and survives power loss.

In accordance with further example implementations, the electronic paper-based display device may be a component other than the above-described electrophoretic display component. As examples, in accordance with further implementations, the electronic paper-based display device may be a microencapsulated electrophoretic display component, an electrowetting display component, an electrofluidic display component, an interferometric modulator display component, a nanostructure display component, a plasmonic display component, and so forth. Moreover, in accordance with further example implementations, the electronic paper-based display device may display colorized visual content that has more than two colors (i.e., produce visual content other than a monochrome output).

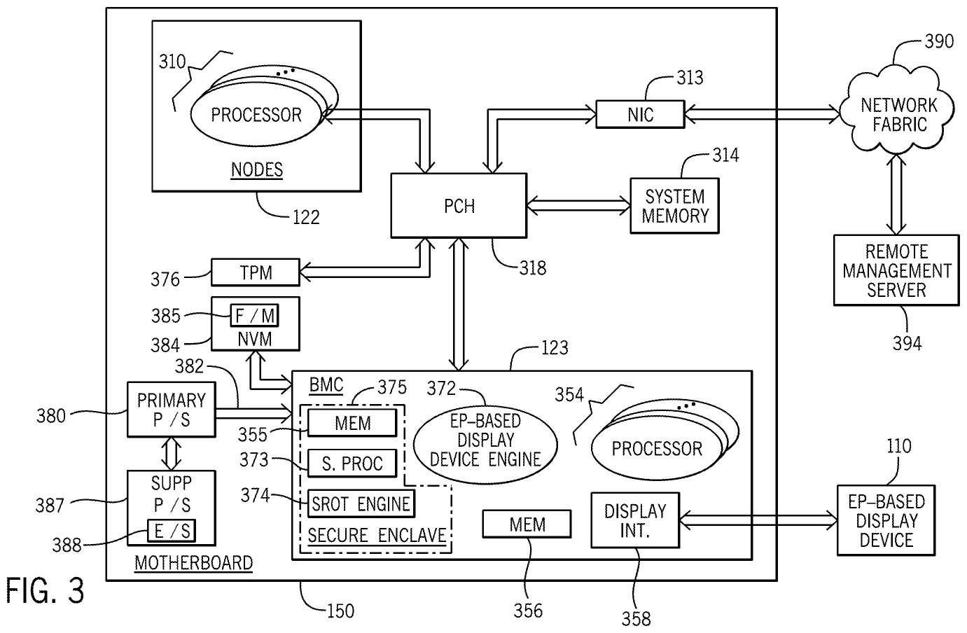

FIG. 3 depicts an example motherboard 150 of the server blade 100 in accordance with some implementations. Referring to FIG. 3 in conjunction with FIG. 1, in accordance with some implementations, the motherboard 150 may include one or multiple processors 310 (e.g., one or multiple CPUs, one or multiple CPU processing cores, one or multiple GPU cores, one or multiple FPGAs, and so forth); and a system memory 314. In accordance with example implementations, groups of the processors 310 form corresponding nodes 122. The system memory 314 and other memories discussed herein are non-transitory storage media that may be formed from semiconductor storage devices, memristor-based storage devices, magnetic storage devices, phase change memory devices, a combination of devices of one or more of these storage technologies, and so forth. The system memory 314 may represent a collection of both volatile memory devices and non-volatile memory devices.

In accordance with example implementations, the server blade 100 contains a management controller, such as the baseboard management controller 123, that, among its other functions, detects node faults and manages the corresponding visual content that appears on the electronic paper-based display device 110. In general, the baseboard management controller 123 may, in accordance with example implementations, perform management functions pertaining to all of the motherboard(s) 150 of the server blade 100. In other words, in accordance with some implementations, the server blade 100 may contain a single baseboard management controller 123, regardless of the number of nodes 122 or the number of motherboards 150 of the server blade 100.

In accordance with example implementations, in addition to the processor(s) 310, the system memory 314 and the baseboard management controller 123, the motherboard 150 may have various other hardware components, such as an input/output (I/O) bridge, or platform controller hub (PCH) 318; one or multiple mass storage devices (not shown); a non-volatile memory 384 (e.g., a flash memory) that stores firmware 385; one or multiple network interface cards (NICs) 313; a trusted platform module (TPM) 376; I/O device interfaces; and so forth.

The baseboard management controller 123, the NIC(s) 313, the TPM 376 and the processors 310 may, in accordance with example implementations, communicate through the PCH 318. For the example implementation of FIG. 3, a NIC 313 couples the PCH 318 to network fabric 390 for purposes of allowing the baseboard management controller 123 to communicate with a remote management server 394 via the network fabric 390. In accordance with further example implementations, the baseboard management controller 123 may contain a network interface controller that allows the baseboard management controller 123 to directly communicate with the network fabric 390.

In general, the network fabric 390 may be associated with one or multiple types of communication networks, such as (as examples) Fibre Channel networks, iSCSI networks, ATA over Ethernet (AoE) networks, HyperSCSI networks, Gen-Z fabrics, dedicated management networks, local area networks (LANs), wide area networks (WANs), global networks (e.g., the Internet), wireless networks, or any combination thereof.

The TPM 376 is an example of a security component of the motherboard 150, which has a secure memory that may be used to store secure information (e.g., the secure boot variables, hashes to verify integrity measurement, keys, and so forth) for the motherboard 150. Examples of TPMs that may be used are commercially available from such vendors as Infineon Technologies, Nuvoton and STMicroelectronics. In accordance with further example implementations, the motherboard 150 may contain a security component other than a TPM. Moreover, in accordance with further implementations, the TPM may be a virtual TPM (vTPM). As such, depending on the particular implementation, the TPM may be implemented in firmware, software or hardware. In accordance with further implementations, the motherboard 150 may not include a TPM. In accordance with some implementations, the particular security component may be shared by all motherboards of the server blade 100.

In accordance with example implementations, the motherboard 150 may have a primary power supply 380, which provides power to one or multiple voltage supply rails 382 to supply power to power consuming components of the server blade 100. The primary power supply 380 may include voltage regulators and power conditioning circuitry, which receive power from the backplane of the rack, convert the voltage into the appropriate supply voltages for the server blade 100, and furnish the supply voltages to the voltage supply rails 382. In accordance with some implementations, the motherboard 150 may include one or multiple secondary, or supplemental, power supplies 387. In general, the supplemental power supply 387 provides additional, or supplemental, power to one or multiple supply voltage rails 382 when the incoming power to the primary power supply 380 is interrupted or turned off (i.e., supply power when the server blade 100 is powered down).

As a more specific example, in accordance with some implementations, the supplemental power supply 387 may include a supplemental stored energy source 388, such as a battery, a super capacitor, or other stored energy source. In accordance with some implementations, the stored energy source 388 may be charged with power that is provided by the primary power supply 380 while the primary power supply 380 receives power (i.e., the stored energy source 388 is charged before the primary power supply 380 is turned off or otherwise no longer functions to provide power for the server blade 100). The primary power supply 380 may, for example, have circuitry that directs power to maintain the stored energy source 388 in a charged state while the primary power supply 380 provides the power for the server blade 100; and the primary power supply 380 may contain circuitry to switch one or multiple supply voltage rails 382 to receive power derived from the stored energy source 388 when power to the primary power supply 380 is interrupted or the primary power supply 380 otherwise shuts down.

The stored energy source 388, in accordance with some implementations, is constructed to provide supplemental power via one or multiple voltage supply rails 382. Although the visual content that is displayed by the electronic paper-based display device 110 is persistent and survives a power loss, supplemental power provided by the stored energy source 388 allows the display device 110 to change or modify its visual content after the server blade 100 has been powered down. For example, as further described herein, although the server blade 100 may be intentionally powered down after the discovery of a fault, the power that is provided by the stored energy source 388 allows the visual content of the electronic paper-based display device to be changed or updated with new visual content (e.g., a diagnosis of the fault, a fault code, and so forth).

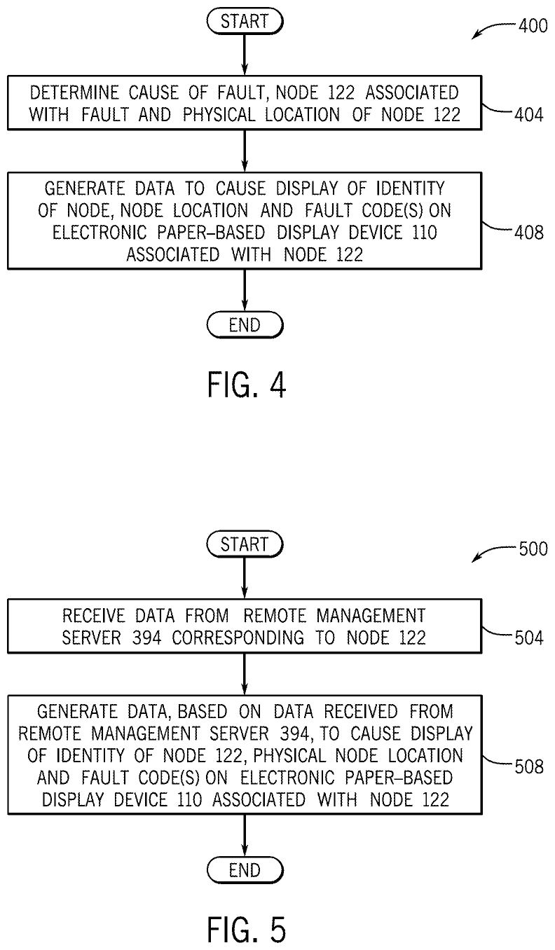

In accordance with example implementations, the baseboard management controller 123 may be an embedded system that is mounted to the motherboard 150. Depending on the particular implementation, the baseboard management controller 123 may contain one or multiple semiconductor packages (or “chips”) and one or multiple semiconductor die. In accordance with further implementations, the baseboard management controller 123 may be an expansion card that is connected to a connector slot disposed on the motherboard 150. The baseboard management controller 123 may not contain semiconductor package(s) mounted to the motherboard or may not be located on an expansion card, in accordance with further implementations. Regardless of its particular form or implementation, the baseboard management controller 123, in general, may include one or multiple general purpose embedded processors cores 354 (e.g., CPU processing cores), which may execute machine executable instructions to provide an electronic paper-based display device driver (herein called an “electronic paper-based display device engine 372” or “display device engine 372”) for the baseboard management controller 123. In general, as further described herein, the display device engine 372 may perform various functions related to detecting faults and providing data to cause the electronic paper-based display device 110 to display visual content, such as the processes 400 and 500 that are described herein in connection with FIGS. 4 and 5, respectively. In accordance with example implementations, the baseboard management controller 123 may have a display interface 358 (e.g., a serial interface, such as a Serial Peripheral Interface (SPI) interface or an I3C interface, or a non-serial interface) that communicates with the display controller 111 (see FIG. 1) of the electronic paper-based display device 110.

As used herein, a “baseboard management controller” is a specialized service processor that monitors the physical state of a server, node, or other hardware entity using sensors and communicates with a management system through a management network. The baseboard management controller 123 may communicate with applications executing at the operating system level through an input/output controller (IOCTL) interface driver, a representational state transfer (REST) application program interface (API), or some other system software proxy that facilitates communication between the baseboard management controller 123 and applications. The baseboard management controller 123 may have hardware level access to hardware devices located on the corresponding server blade 100, including system memory, local memories, and so forth. The baseboard management controller 123 may be able to directly modify the hardware devices. The baseboard management controller 123 may operate independently of the operating system instances of the server blade 100 and operate independently of the nodes 122 of the server blade 100. The baseboard management controller 123 may be located on a motherboard or main circuit board of the server blade 100. The fact that the baseboard management controller 123 is mounted on a motherboard of the managed server blade 100 or otherwise connected or attached to the managed server blade 100 does not prevent the baseboard management controller 123 from being considered “separate” from the nodes 122 of the server blade 100, which are being monitored/managed by the baseboard management controller 123. As used herein, a “baseboard management controller” has management capabilities for sub-systems of a computing device, and is separate from a processing resource that executes an operating system of the computing device. As such, the baseboard management controller 123 is separate from the nodes 122, which execute high-level operating system instances.

In accordance with example implementations, the baseboard management controller 123 may have a management plane and a separate, security plane. Through its management plane, the baseboard management controller 123 may provide various management services for the server blade 100. In general, the baseboard management controller 123 may provide various management services for the server blade 100, such as monitoring sensors (e.g., temperature sensors, cooling fan speed sensors, intrusion sensors, and so forth); monitoring operating system status; monitoring power statuses; logging server blade 100 events; providing remotely controlled management functions for the server blade 100; and so forth. Through its security plane, the baseboard management controller 123 may provide various security functions, or services, for the motherboard 150, such as key management (e.g., functions relating to storing and loading cryptographic keys), firmware image validation, platform cryptographic identity retrieval, measurement hash loading, measurement hash retrieval, and so forth.

The security plane of the baseboard management controller 123, in accordance with example implementations, is formed by a secure enclave 375 of the controller 123, which may include a security processor 373 (e.g., a CPU processing core); a non-volatile memory e.g., a memory, not shown, to store cryptographic keys, a cryptographic identity, seeds, and so forth); a volatile memory 355 (e.g., a memory to store firmware that is loaded into the volatile memory 355 and executed by the security processor 373); a secure bridge (not shown) to control access into the secure enclave and control outgoing communications from the secure enclave; cryptographic-related peripherals (not shown), such as cryptographic accelerators, a random number generator, a tamper detection circuit, and so forth; and a hardware or “silicon” Root of Trust (RoT) engine, called the “SRoT engine 374” herein. In accordance with example implementations, the secure enclave 375 uses the SRoT engine 374 to validate firmware to be executed by the security processor 373 before the SRoT engine 374 loads the firmware into the secure enclave's volatile memory 355 and allows the security processor 373 to execute the firmware.

The embedded processing core(s) 354 execute firmware instructions from a memory 356 of the controller 123 to provide various management services for the controller 123 as part of the controller's management plane. As part of the management services, the general purpose processing core(s) 354 may execute instructions that are stored in the memory 356 to provide the display device engine 372.

In accordance with example implementations, the display device engine 372 may detect a fault with one or multiple nodes 122 of the server blade 100. The display device engine 372 may detect a fault based on direct observations made by the baseboard management controller 123 or based on observations made by other components of the server blade 100. In response to detecting a fault, in accordance with example implementations, the display device engine 372 generates data representing a visualization of information relating to the fault and communicates this data to the electronic paper-based display device 110.

As a more specific example, the display device engine 372 may detect a fault for one or multiple nodes 122 of the server blade 100 based on information (e.g., information conveyed by data, an electrical signal, and so forth) from one or multiple sensors of the server blade 100. For example, the display device engine 372 may observe, based on the output of a temperature sensor of the server blade 100, that a CPU temperature (as an example) has exceeded a predefined temperature threshold, and correspondingly, the display device engine 372 may determine that a CPU temperature fault, which corresponds to one or multiple nodes 122, has occurred. As another example, the display device engine 372 may monitor a chassis intrusion sensor for the server blade 100, which provides a signal representing whether physical tampering with the server blade 100 has been detected. In response to the intrusion sensor indicating that such tampering has occurred, the display device engine 372 may determine that a corresponding fault has been detected for all of the nodes 122 of the server blade 100.

In accordance with example implementations, display device engine 372 may detect a fault by monitoring an operating system process and determining that a fault has occurred based on one or multiple characteristics of the monitored process. For example, in accordance with some implementations, the baseboard management controller 123 may contain a scanning engine (e.g., an engine formed from hardware, machine executable instructions or a combination thereof), such as the scanning engine that is described in U.S. Patent Application Publication Number 2019/0384918. The scanning engine may or may not be part of the display device engine 372, depending on the particular implementation. The scanning engine may, for example, scan kernel data structures, kernel code and loadable kernel modules for purposes of ensuring that the operating system kernel and its extensions have not changed. If the operating system kernel or any of its extensions have changed, however, the display device engine 372 may detect this occurrence using the scanning engine and correspondingly determine that one or multiple faults are detected for the corresponding nodes 122.

As another example, in accordance with some implementations, the baseboard management controller 123 may validate software or firmware executing on a particular node 122, and based on the results of this validation, the display device engine 372 may determine that a software fault has occurred for a particular node 122. For example, in accordance with some implementations, the validation of the firmware 385 by the security processor 373 may fail; and when this occurs, the display device engine 372 may determine that a corresponding software fault has occurred. The firmware 385 may, for example, contain a boot code image executed by a designated boot processor 310 to boot up the motherboard 150; machine executable instructions corresponding to a management stack executed by the baseboard management controller 123 to provide a wide variety of different management services for the motherboard 150; machine executable instructions executed by the security processor 373 to provide various security services for the motherboard 150; and so forth. In accordance with some implementations, the baseboard management controller 123 may hold its general purpose processing core(s) 354 of the controller 123 in reset at power up of the motherboard 150, until the firmware 385 is validated.

As another example of the display device engine 372 detecting a fault, in accordance with some implementations, the display device engine 372 may periodically review a system event log, and based on predefined events being in the log, display device engine 372 may determine that one or possibly multiple faults have occurred.

In accordance with some implementations, the display device engine 372 may determine that a particular fault has occurred based on events that are consistent with faults. For example, in accordance with some implementations, the baseboard management controller 123 may determine that a fault has occurred if a predetermined time has elapsed for a particular node 122 to fully boot. As another example, in accordance with some implementations, the display device engine 372 may determine that a particular fault has occurred in response to a node 122 being cycled a number of times back to its reset state.

As another example, the display device engine 372 may determine that a fault has occurred based on a driver not being validated by a boot processor 310 of the server blade 100. For example, the server blade 100 may undergo a secure boot, which establishes a chain of trust for purposes of inhibiting the execution of malware on the server blade. As part of the secure boot, the boot processor 310 may check code to be loaded against a permitted secure boot key database and a not permitted secure boot key database by using a public key infrastructure (PKI) to authenticate the code. In accordance with some implementations, the boot processor 310, in response to the failure to authenticate code to be loaded, may generate an interrupt (e.g., a system management interrupt (“SMI”)) or provide another notification to alert the baseboard management controller 123 to the code check failure. Accordingly, in accordance with some implementations, the display device engine 372 may determine that a particular fault has occurred in response to such a communication from the boot processor 310 and display the appropriate visual content on the electronic paper-based display device 110.

In accordance with further example implementations, malware protection software executing on the node 122 may alert the baseboard management controller 123 when malware has been detected. Accordingly, when this occurs, the display device engine 372 may generate data to display the corresponding visual content on the electronic paper-based display device 110.

It is noted that regardless of how the display device engine 372 detects or determines the fault, the process of detecting the fault and/or the processing of determining information about the fault may extend beyond the time period in which the server blade 100 remains powered on. For example, upon receiving notification of a fault, the baseboard management controller 123 may be instructed by the remote management server 394 to power down the server blade 100. The visual content that is displayed on the electronic paper-based display device 110 may still be augmented or changed, however, due to power that is provided by the stored energy source 388. It is noted that, in accordance with example implementations, the baseboard management controller 123 may receive power (other than the power that is provided by the stored energy source 388) when the components of the server blade 100 are otherwise powered down, for purposes of allowing the baseboard management controller 123 to provide its remotely-controlled management functions for the server blade 100.

In accordance with example implementations, the baseboard management controller 123 may not directly or indirectly determine, detect or identify a particular fault. Rather, in accordance with some implementations, a management server, such as the remote management server 394, may communicate with the baseboard management controller 123 over a management network channel for purposes of instructing the baseboard management controller 123 to cause the display of specific information on the electronic paper-based display device 110. For example, in accordance with some implementations, a cluster administrator or a service technician may, for example, through the remote management server 394, communicate a command to the display device engine 372, instructing the engine 372 to display specific visual content on the electronic paper-based display device 110. The command may be accompanied by data that represents the specific visual content to be displayed. It is noted that the communication of the command and the corresponding visual content data may occur after the server blade 100 has been powered down (e.g., after the remote management server 394 has remotely powered down the server blade 100), with the stored energy source 388 allowing the visual content of the electronic paper-based display device 110 to be updated.

In accordance with some implementations, the baseboard management controller 123 may be unaware of the specific content (e.g., node location, node fault, and so forth) that is represented by the data accompanying the command. However, in accordance with further implementations, the display device engine 372 may recognize the content and based on the content, generate further data to supplement the visual content that is displayed on the device 110. For example, the display device engine 372 may supplement the content with visual content representing the location of the server blade and/or node.

Referring to FIG. 4 in conjunction with FIG. 3, in accordance with some implementations, the baseboard management controller 123 may perform a process 400 in response to a particular node 122 experiencing a hardware and/or software fault. Pursuant to the process 400, the baseboard management controller 123 determines (block 404) the cause of the fault, the node 122 associated with the fault and location information for the node 122. For example, the baseboard management controller 123 may determine the cause of the fault by examining sensor outputs, register values, and so forth. Pursuant to block 408, the baseboard management controller 123 generates data to cause display of the node, the node location and any relevant fault code(s) on the electronic paper-based display device 110.

Referring to FIG. 5, in accordance with some implementations, the baseboard management controller 123 may perform a process 500, which allows the display content of the electronic paper-based display device 110 to be controlled (e.g., updated) remotely, such as, for example, from the remote management server 394. For example, a remote user (e.g., a cluster administrator, a service technician, and so forth) may communicate with the baseboard management controller 123 for purposes of displaying a diagnosis for a node fault, a fault code, location information for the node, and so forth. Pursuant to the process 500, the baseboard management controller 123 receives (block 504) data from the remote management server 394 and generates (block 508) data to cause the electronic paper-based display device 110 to display content corresponding to the data received from the remote management server 394.

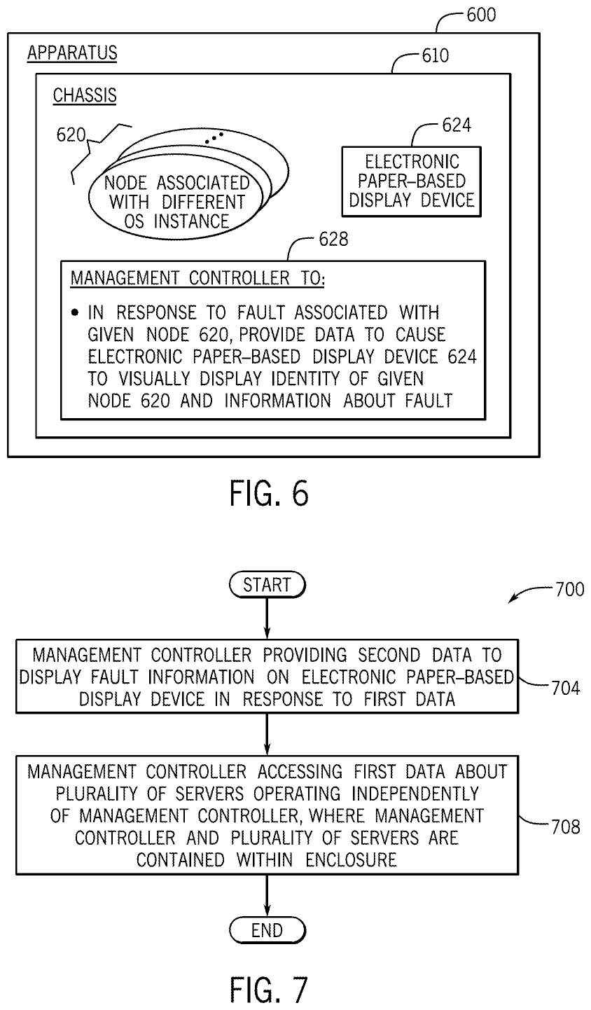

Referring to FIG. 6, in accordance with example implementations, an apparatus 600 includes a chassis 610; a plurality of nodes 620 that are mounted to the chassis 610; an electronic paper-based display device 624 that is mounted to the chassis 610; and a management controller 628 that is mounted to the chassis 610. Each node 620 is associated with a different operating system instance of a plurality of operating system instances. The management controller 628, in response to a fault associated with a given node 620, provides data to cause the electronic paper-based display device 624 to visually display an identity of the given node 620 and information about the fault.

Referring to FIG. 7, in accordance with example implementations, a process 700 includes a management controller accessing (block 704) first data about a plurality of servers, which operate independently of the management controller. The management controller and the plurality of servers are contained within an enclosure. The process 700 includes the management controller providing (block 708) second data to display fault information on an electronic paper-based display device in response to the first data.

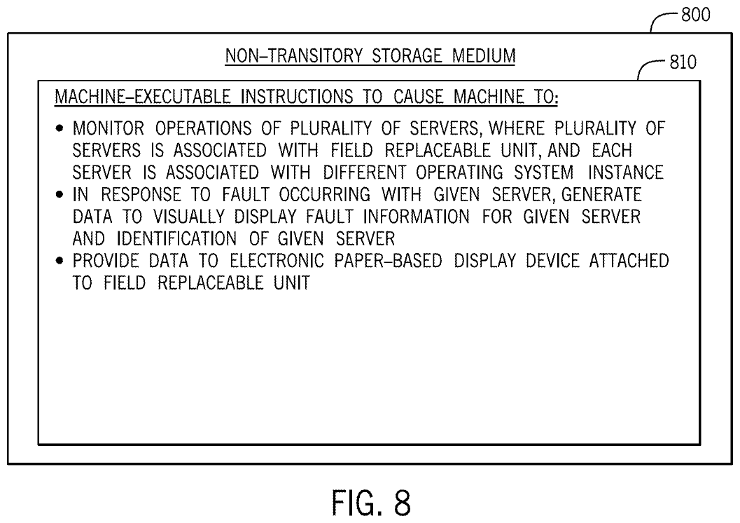

Referring to FIG. 8, in accordance with example implementations, a non-transitory machine-readable storage medium 800 stores machine-executable instructions 810. The instructions 810, when executed by a machine, cause the machine to monitor operations of a plurality of servers. The plurality of servers is associated with a field replaceable unit; and each server is associated with a different operating system instance of a plurality of operating system instances. The instructions 810, when executed by the machine, further cause the machine to, in response to a fault occurring with a given server, generate data to visually display fault information for the given server and an identification of the given server; and provide the data to an electronic paper-based display device, which is attached to the field replaceable unit.

In accordance with example implementations, the apparatus includes a server blade, and the management controller includes a baseboard management controller. A particular advantage is that a specific fault and node location information may be attached as a persistent label to the server blade.

In accordance with example implementations, the management controller autonomously identifies the fault and generates the data based on the identified fault. A particular advantage is that a specific fault and node location information may be attached as a persistent label to the server blade.

In accordance with example implementations, the management controller communicates with a remote management server to receive the data. A particular advantage is that a persistent label identifying node fault and location information, which is attached to the server blade, may be remotely modified.

In accordance with example implementations, the electronic paper-based display device is slidably mounted to the chassis to move from a first location that is positioned within a recess of the chassis to an extended second location in which the display device is moved outside of the recess. A particular advantage is that the electronic paper-based display device maintains a low profile until used to retrieve the node fault and location information.

In accordance with example implementations, the management controller provides data representing a location of the given node. A particular advantage is that inadvertent removal of the incorrect node or incorrect FRU is avoided.

In accordance with example implementations, the apparatus includes a server blade; and the location includes at least one of a row identification, a rack identification, a chassis unit identification, or a server blade identification. A particular advantage is that inadvertent removal of the incorrect node or incorrect FRU is avoided.

In accordance with example implementations, the data represents multiple display content pages, and the apparatus further includes an input device to control which page of the plurality of pages is displayed on the display device. A particular advantage is that multiple, persistent pages of visual content for the given node and the associated fault may be maintained.

In accordance with example implementations, an energy storage device may be included to provide a supplemental stored energy source to the display device to allow displayed content of the display device to be changed after a primary power supply to the plurality of nodes has been removed. A particular advantage is that the displayed content on the electronic paper-based display device may be changed after primary power has been removed from the apparatus.

While the present disclosure has been described with respect to a limited number of implementations, those skilled in the art, having the benefit of this disclosure, will appreciate numerous modifications and variations therefrom. It is intended that the appended claims cover all such modifications and variations.

1. An apparatus comprising:
a chassis having a form factor to allow the chassis to be removably installed in a slot of a plurality of slots of a rack;
a plurality of nodes mounted to the chassis, wherein each node of the plurality of nodes is associated with a different operating system instance of a plurality of operating system instances;
an electronic paper-based display device mounted to the chassis such that the electronic paper-based display device is to be installed with the chassis when the chassis is installed in the slot and removed with the chassis when the chassis is removed from the slot; and
a management controller mounted to the chassis to, in response to a fault associated with a given node of the plurality of nodes, provide data to cause the electronic paper-based display device to visually display an identity of the given node and information about the fault.

2. The apparatus of claim 1, wherein the chassis comprises a server blade, and the management controller comprises a baseboard management controller.

3. The apparatus of claim 1, wherein the management controller is to autonomously identify the fault and generate the data based on the identified fault.

4. The apparatus of claim 1, wherein the management controller is to communicate with a remote management server to receive the data.

5. The apparatus of claim 1, wherein the electronic paper-based display device is slidably mounted to the chassis to move from a first location positioned within a recess of the chassis to an extended second location in which the electronic paper-based display device is moved outside of the recess.

6. The apparatus of claim 1, wherein the management controller is to provide data to represent a location of the given node.

7. The apparatus of claim 6, wherein:
the apparatus comprises a server blade; and
the location comprises at least one of a row identification, a rack identification, a chassis unit identification, or a server blade identification.

8. The apparatus of claim 1, wherein the data represents multiple display content pages, the apparatus further comprising an input device to control which page of the plurality of pages is displayed on the electronic paper-based display device.

9. The apparatus of claim 1, further comprising an energy storage device to provide a supplemental stored energy source to the electronic paper-based display device to allow displayed content of the electronic paper-based display device to be changed after a primary power supply to the plurality of nodes has been removed.

10. The apparatus of claim 9, wherein the supplemental stored energy source comprises a super capacitor or a battery.

11. A method comprising:
a baseboard management controller accessing first data about a plurality of nodes operating independently of the baseboard management controller, wherein the baseboard management controller and the plurality of nodes are part of a computer platform mounted to a chassis, the chassis having a form factor to allow the chassis to be removably installed in a slot of a plurality of slots of a rack, the baseboard management controller comprising a service processor to operate independently of the plurality of nodes to perform management functions for the computer platform, the management functions comprising at least one management function to be controlled remotely relative to the computer platform via communication between the baseboard management controller and a remote management server, and each node of the plurality of nodes corresponds to a single operating system instance; and
the baseboard management controller providing second data to display fault information on an electronic paper-based display device mounted to the chassis in response to the first data, wherein the baseboard management controller providing the second data comprises the baseboard management controller providing data that represents an identity of a given node of the plurality of nodes to cause the electronic paper-based display device to display the identity.

12. The method of claim 11, wherein the baseboard management controller accessing the first data comprises the baseboard management controller receiving the first data from the remote management server.

13. The method of claim 12, wherein the first data represents state information about the given node, the method further comprising the baseboard management controller identifying a fault with the given node based on the state information.

14. The method of claim 12, further comprising providing supplemental power to allow changes to the electronic paper-based display device in response to a primary source of power for the plurality of nodes being interrupted.

15. (canceled)

16. A non-transitory machine-readable storage medium that stores machine-executable instructions that, when executed by a machine, cause the machine to:
monitor operations of a plurality of servers, wherein the plurality of servers is associated with a field replaceable unit, the field replaceable unit constructed to be installed in a slot of a rack and removed from the slot, the plurality of servers to be installed in the slot with the field replaceable unit and removed from the slot with the field replaceable unit, and each server of the plurality of servers is associated with a different operating system instance of a plurality of operating system instances;
in response to a fault occurring with a given server of the plurality of servers, generate data to visually display fault information for the given server and an identification of the given server; and
provide the data to an electronic paper-based display device attached to the field replaceable unit such that the electronic paper-based display device is installed with the field replaceable unit in the slot and removed with the field replaceable unit from the slot.

17. The storage medium of claim 16, wherein the instructions, when executed by the machine, further cause the machine to detect the fault in response to the monitored operations.

18. The storage medium of claim 16, wherein the instructions, when executed by the machine, further cause the machine to communicate with a remote management server to receive data representing the fault.

19. The storage medium of claim 16, wherein the instructions, when executed by the machine, further cause the machine to provide data to the electronic paper-based display device to display visual content representing a physical location of the given server.

20. The storage medium of claim 16, wherein the machine comprises a baseboard management controller, and the given server comprises a node disposed on a server blade.
